(19) United States
(12) Patent Application Publication
(10) Pub. No.: US 2026/0045669 A1
(43) Pub. Date: Feb. 12, 2026

(54) DEVICE AND METHOD FOR FILLING AND SEALING A BATTERY CELL

(71) Applicant: Innolith Technology AG, Basel (CH)

(72) Inventors: Laurent Zinck, Mothern (FR); Markus Borck, Stuttgart (DE); Anna Urbanski, Bruchsal (DE); Julia Thümmel, Bruchsal (DE); Benjamin Haitz, Durmersheim (DE); Sven Haase, Forst (DE); Cèsar Arauzo Llobet, Mannheim (DE)

(21) Appl. No.: 19/285,234

(22) Filed: Jul. 30, 2025

(30) Foreign Application Priority Data
Aug. 9, 2024 (EP) 24 193 917.2

(51) Int. Cl. H01M 50/627

(52) U.S. Cl. CPC H01M 50/627

(57) ABSTRACT

A device for filling a battery cell with an electrolyte and for subsequently sealing the battery cell is disclosed. The device includes a process chamber that has a receiving opening in which the battery cell is at least partially accommodated, such that a filling opening of the battery cell is arranged in the process chamber. The chamber has an opening suitable for receiving a line for filling the battery cell. The process chamber is gas-tight and liquid-tight with the battery cell and line. The process chamber has a passage through which laser beams can pass to close the filling opening of the battery cell so that the battery cell can be filled with the electrolyte and then sealed. A method of using the device to fill a battery cell with electrolyte is also disclosed.

### RELATED APPLICATIONS

This application claims priority to EP 24 193 917.2, filed Aug. 9, 2024, the entire disclosure of which is hereby incorporated herein by reference.

### BACKGROUND

This disclosure relates to a device for filling a battery cell with an electrolyte and for subsequently sealing said battery cell. Furthermore, this disclosure relates to a method for filling a battery cell with an electrolyte and subsequently sealing said battery cell with the above-mentioned device.

Rechargeable battery cells are of great importance in many technical fields. They are often used for applications that only require small, rechargeable battery cells with relatively low current levels, such as mobile phones. In addition, however, there is also a great need for larger, rechargeable battery cells for high-energy applications, with a mass storage of energy in the form of battery cells for electrically driven vehicles being of particular importance.

The commercially available rechargeable battery cells are so-called lithium-ion battery cells. This type of battery cell uses organic electrolytes (organic lithium-ion batteries) in which a conductive salt is dissolved in one or more liquid organic solvents. For example, the electrolyte LP30 is made from a 1 molar solution of lithium hexafluorophosphate (LiPF₆) in a mixture consisting of the organic solvents ethylene carbonate (EC) and dimethyl carbonate (DMC) in a mass ratio of 1:1.

Further developments of lithium-ion battery cells that are also known from the prior art provide for the use of SO₂-based electrolytes instead of organic electrolytes for rechargeable battery cells.

In the context of this disclosure, the term “SO₂-based electrolyte” is to be understood as referring to an electrolyte that not only contains SO₂ as an additive at a low concentration, but in which the mobility of the conductive salt ions contained in the electrolyte and causing the charge transport, is at least partially, largely, or even fully ensured by SO₂. The SO₂ thus serves as a solvent for the conductive salt. The conductive salt can form a liquid solvate complex with the gaseous SO₂, with the SO₂ being bound and the vapor pressure being noticeably reduced compared to pure SO₂. This results in electrolytes with a low vapor pressure. Such electrolytes based on SO₂ have the advantage that, compared to the organic electrolytes described above, they are non-combustible. Safety risks which are due to the flammability of the electrolyte can thus be ruled out.

Due to the fact that the demand for battery cells is constantly growing, there will be increasing interest in producing the rechargeable battery cells described above as efficiently and cost-effectively as possible.

The production of a battery cell also includes filling the battery cell with the desired organic or SO₂-based electrolyte and then sealing the battery. The filling and subsequent sealing are key process steps in the production of rechargeable battery cells that directly influence the service life and performance of the battery cells. In addition to product quality, the filling time is important as well. The longer the filling step takes, the more cost-intensive this process step is.

According to prior art, organic lithium-ion batteries in round cells up to approximately 32 mm in diameter are usually manufactured with a so-called open filling process. In this manufacturing process, the battery housing, which is open, i.e., without a lid, is filled with the organic electrolyte. After the interior of the housing is completely filled with the electrolyte, the open housing of the battery cell is sealed with a lid. Large round cells or prismatic cells are filled through openings in the lid component. In the case of open filling, however, complex measures are necessary to avoid contamination of the interior of the battery cell with, for example, moisture from the air. Furthermore, the known production process takes a very long time until the entire cell interior is filled with the organic electrolyte. In “Prospects for reducing the processing cost of lithium ion batteries” (David L. Wood III, Jianlin Li, Claus Daniel Journal of Power Sources 275 (2015) 234-242) a period of two to three days is mentioned until the battery cell is completely wetted with the electrolyte. This makes the production process complex, time-consuming, and costly. This is reflected in the price of the battery cell.

U.S. Pat. No. 3,911,972 A relates to the filling of battery cells with an aqueous electrolyte solution, such as potassium hydroxide. It proposes a method that is improved over those known from prior art (immersion of the entire battery cell in the electrolyte solution) for filling battery cells with an aqueous electrolyte solution. The process describes the filling of battery cells with a precise amount of liquid within a hermetically sealed chamber. In the method that is disclosed, the upper part of the housing is first inserted into the sealed opening of the chamber. Then, a negative pressure is created in the chamber, causing the interior of the chamber and the battery cell accommodated therein to be evacuated. After precisely measuring the amount of electrolyte required to fill each battery cell, a tight connection is established between the filling opening of the liquid supply device and the measured amount of electrolyte is filled through the filling opening of the housing under the influence of overpressure.

The document further describes a device for carrying out the method comprising a hermetically sealed chamber with a first, a second, and a third opening. The first opening comprises the filling head, which extends into the filling chamber to seal the filling opening and is used to supply the exact amount of liquid. The second opening comprises the upper part of the battery cell housing, including the filling opening, which can be moved towards the filling head. Furthermore, the device comprises openings for evacuation purposes or for applying overpressure.

The SO₂-based electrolytes form a solvate structure through the interaction of the gaseous SO₂ with the conductive salt, which leads to the increased vapor pressure of the electrolyte. This in turn leads to SO₂ escaping in the open system, which promotes the crystallization of the conductive salt when the SO₂ content of the electrolyte is reduced, e.g., when a vacuum is created. Crystallization can occur, for example, in the lines of a filling device or at a filling opening of the battery. These problems are known and various solutions are proposed in prior art.

DE 199 118 00 C1 discloses a method and a device for filling an electrochemical cell, which is intended to solve the above-mentioned problems associated with SO₂-based electrolytes. As a solution to the issues, DE 199 118 00 C1 proposes a complicated device in which a cannula must be inserted through an inlet opening of the battery up to the electrode stack in a gas-tight manner. However, this poses the risk that the end of the cannula could damage the electrode stack and cause an internal short circuit, or that the cannula could become clogged with crystallized conductive salt. To fill the battery cell, the battery cell is evacuated and, after a valve is turned, the electrolyte solution is sucked into the cell.

U.S. Pat. No. 9,209,458 B2 proposes another method for filling battery cells with an SO₂-based electrolyte solution. In contrast to DE 199 118 00 C1, no cannula is inserted into the battery cell, but the filling opening is connected to the filling system, as described, for example, in the above-mentioned U.S. Pat. No. 3,911,972 A, in a gas-tight manner. The process includes the following steps:
1. A cell housing containing a positive and a negative electrode is evacuated;
2. The interior of the housing is filled with gaseous SO₂;
3. Steps 1 and 2 are repeated if necessary;
4. The housing is evacuated;
5. A filling opening of the housing is connected in a gas-tight manner to a tank containing an electrolyte solution with a predetermined concentration of SO₂; and
6. The electrolyte solution flows into the housing, driven by a pressure exerted on the electrolyte and by the vacuum that exists in the housing.

A similar procedure is proposed for battery cells cooled to −20° C. They are filled by means of the filling tube (30). Said tube is attached to the lid, between the two battery poles, as can be seen in FIG. 9 and FIG. 10 of U.S. Pat. No. 9,209,458 B2. This has the significant disadvantage that there is not enough space between the two battery poles.

DE 10 2022 201 087 A1 relates to a method for filling and sealing a battery cell which has a housing element with a filling opening. In a first step, a hollow body having a through-opening is guided through the filling opening and, in a first joining phase, is connected to the housing element by means of a plastic deformation in such a way that the through-opening is at least partially retained. In a second step, the through-opening is used to fill the battery cell housing with electrolyte and/or for degassing purposes. In a third step, the through-opening is completely sealed.

However, none of the methods and associated devices described in the prior art provide a device and method for filling and sealing the electrolyte-filled battery cells within this single device so that a sealed battery cell, ready for use, can be removed from the device.

### SUMMARY

This disclosure teaches a device and a method for filling a battery cell with an electrolyte and subsequently sealing the battery cell, in which:
the filling and sealing takes place within a single device;
the filling times are reduced in comparison with the prior art;
all types of battery cells can be filled and sealed;
no electrolyte or solvent escapes when the battery cell is disconnected;
the crystallization of conductive salt within the device is avoided;
the device makes it possible for the filling to be carried out in a stable manner and with the highest precision;
the filling opening of the battery cell is produced simply, quickly, and efficiently;
the filling opening of the battery cell is arranged in such a way that the space required for the electrode coil or stack is not affected;
the battery cell filler opening is arranged in such a way that the space required for the electrode terminals and additional elements, e.g., the rupture disc, in the lid component is not affected;
all components of the battery cell are completely saturated with the electrolyte after the filling in order to ensure good battery cell performance;
no concentration gradients occur in the battery cell during filling;
reactions between electrolyte and battery cell components are minimized;
special measures for water-sensitive electrolytes can be dispensed with; and
the filled battery cell can be sealed immediately.

The device according to this disclosure for filling a battery cell with an electrolyte and for subsequently sealing said battery cell comprises a process chamber. The process chamber is provided with a receiving opening in which the battery cell is at least partially accommodated such that a filling opening of the battery cell is arranged in the process chamber. Furthermore, the process chamber has an opening which is suitable for receiving at least one line for filling the battery cell. The process chamber is designed in such a way that the process chamber, the accommodated battery cell and the line are gas-tight and liquid-tight. In addition, the process chamber has a passage through which the laser beams can pass to seal the filling opening of the battery cell, so that the battery cell at least partially accommodated in the process chamber can be filled with the electrolyte and then sealed.

The terms “gas-tight” and “liquid-tight” are used in the context of this disclosure to express the inability of a gas or liquid to enter or leave a device.

The term “by means of laser beams for sealing” is to be understood in the context of this disclosure to mean that this is laser welding, often also referred to as laser beam welding. In laser welding, the welding is carried out by using laser energy. The laser beam is optically focused so that a high energy input causes a very small area to melt. During laser welding, the molten pool is protected from oxidation by a protective gas, usually argon. In the weld pool, the workpieces and the filler metal are combined to form a weld seam. By focusing the laser beam, the heat input is limited to a small part of the workpiece, causing the weld seam to cool quickly—a result of the high temperature gradient between the welded region and the entire workpiece. Alternatively, additive welding is possible by introducing the welding material into the process chamber near the filling opening prior to the welding process.

The device according to this disclosure has the considerable advantage that the two steps, namely, filling and sealing the battery cell, can be carried out in a single device. This helps to make the production of battery cells significantly more efficient. Furthermore, the device according to this disclosure can, due to its simple construction, be designed in such a way that battery cells of various designs can be accommodated. This contributes to the device being widely used.

In a further advantageous embodiment of the device according to this disclosure, the passage is made of a laser beam-permeable material.

The term “laser beam permeable material” is to be understood in the context of this disclosure to mean that the material is permeable to the laser beams. Accordingly, any material that is suitable for laser welding is to be understood as laser beam-permeable material within the meaning of this disclosure.

This configuration has the advantage that the process chamber and hence the device according to this disclosure remains gas-tight and liquid-tight without any additional measures on the one hand and, on the other hand, ensures that the battery cell can be sealed simply by laser welding, as described in detail above.

In a further advantageous embodiment of the device according to this disclosure, the laser beam-permeable material is selected from the group comprising: Glass, diamond, sapphire, polymers, and thin/thick film coatings and glass fiber reinforced plastics.

The term “glass” in the context of this disclosure is to be understood to mean that it is an amorphous, inorganic solid produced from quartz sand, lime, and soda powder that is melted and subsequently cooled in a controlled manner. The term covers all types of glass.

The term “diamond” in the context of this disclosure is to be understood to refer to the cubic modification of the carbon and as a naturally occurring solid mineral from the mineral class the elements. Diamond usually forms octahedral crystals, often with curved and streaked surfaces.

The term “sapphire” in the context of this disclosure is to be understood as the blue, but also yellow, green, violet, and white/colorless variety of the mineral corundum.

The term “polymers and thin/thick film coatings” is to be understood in the context of this disclosure to include all commercially available and laboratory-produced polymers and coatings.

The term “glass fiber reinforced plastics” is to be understood in the context of this disclosure to mean that these are a composite material in which a plastic matrix is modified by the addition of glass fibers. Glass fibers are the most commonly used reinforcing fibers in reinforced polymers. As a possible basis, thermosetting plastics (e.g., polyester resin [UP] or epoxy resin) or thermoplastic plastics (e.g., polyamide) can be taken into consideration.

In an advantageous embodiment of the device according to this disclosure, the laser beam-permeable material is a laser beam-permeable glass, preferably a quartz glass (SiO₂).

This embodiment has the advantage that the device according to this disclosure can be produced in a cost-effective manner.

In a further advantageous embodiment of the device according to this disclosure, the part of the passage facing the interior of the process chamber is provided with a movable lid.

This design has the advantage that the passage made of a laser beam-permeable material can, if necessary, be protected from process gases or liquids located in the interior of the battery cell.

In a further advantageous embodiment of the device according to this disclosure, the laser beam strikes the filling opening of the battery cell at an angle of preferably 90°, more preferably 80°, more preferably 75°, even more preferably 70°, and particularly preferably 65°.

This design has the advantage that it allows for a maximum energy transfer during the sealing process, allowing this step to be carried out in an efficient manner. The oblique alignment of the laser beam prevents any damage within the battery cell, e.g., to the electrode coil or electrode stack.

It is also conceivable that a spacer, preferably in ring form, is placed inside the housing of the battery cell around the filling opening in order to protect the electrodes.

In a further advantageous embodiment of the device according to this disclosure, the filling opening is formed in a housing of the battery cell.

This design has the advantage that the filling opening of the battery cell is designed to be less complex than the solutions known from prior art. It can, for example, be configured as a simple hole in the housing, which is much easier to produce than a complex welded filling tube in the housing lid.

In a further advantageous embodiment of the device according to this disclosure, the filling opening is arranged in the bottom region of the housing of the battery cell.

This design ensures that the structure of the lid component is independent of the filling opening and thus provides more space for the electrode coil or stack.

In a further advantageous embodiment of the device according to this disclosure, the filling opening has a diameter of 5,000 μm, preferably 2,500 μm, more preferably 1,000 μm, even more preferably 750 μm, always more preferably 500 μm and particularly preferably 250 μm.

In a further advantageous embodiment of the device according to this disclosure, the filling opening is round.

In a further advantageous embodiment of the device according to this disclosure, the filling opening is angular, e.g., square or rectangular.

In the event of a square design, the sides have a length between 100 μm and 5,000 μm, more preferably between 150 μm and 2,500 μm and particularly preferably between 200 μm and 1,000 μm.

In a further advantageous embodiment of the device according to this disclosure, the filling opening is not located centrally in the bottom of the battery cell.

In a further advantageous embodiment of the device according to this disclosure, the line is designed to be movable in such a way that it can be placed in such a way that the filling opening is sealed by means of the line with regard to the interior of the process chamber.

This design has the advantage that the electrolyte does not first enter the process chamber and then the battery cell but rather ensures that the electrolyte enters the battery cell directly through the line via the filling opening.

In a further advantageous embodiment of the device according to this disclosure, the process chamber has further openings in which further lines can be accommodated in a gas-tight manner, wherein the lines are arranged movably within the openings.

This design has the advantage that, while the first line is used exclusively for transporting the electrolyte, the additional lines can be used to introduce process gases such as SO₂, inert gases such as N₂, Ar, or welding gases such as helium, argon or protective gas mixtures such as the LASAL protective gas mixtures from Air Liquid into the process chamber as necessary, or to create a vacuum in the process chamber. A separate vacuum line also makes it possible for the desired vacuum to be generated more quickly. By creating a vacuum in the process chamber, a vacuum is also created in the battery cell arranged in the process chamber. This can be advantageous for filling the battery cell with electrolyte. This line can also be used to remove gases from the process chamber. This also simplifies maintenance of the process chamber.

The device according to this disclosure is suitable for filling and sealing battery cells with a wide variety of electrolytes.

In a further advantageous embodiment of the device according to this disclosure, the electrolyte is an electrolyte comprising one or more organic solvents.

Organic liquid electrolytes are widely used in commercially available lithium-ion batteries. Liquid electrolytes in which a conductive salt is dissolved facilitate an efficient ion flow and therefore have better conductivity than solid electrolytes. Different conductive salts and solvents can be flexibly combined to adapt properties such as viscosity, conductivity, temperature resistance, etc. Liquid organic electrolytes also offer low internal resistance compared to solid electrolytes.

However, electrolytes with organic solvents have disadvantages as well. They can evaporate and decompose over time. In addition, safety risks can arise because some liquid electrolytes are highly flammable and can release toxic gases. In addition, the conductivity of liquid electrolytes can decrease at extreme temperatures. The choice of electrolyte depends on the specific requirements of the battery, including performance, safety, and environmental compatibility.

Most of the lithium-ion electrolytes currently used use LiPF₆ as the salt because LiPF₆ solutions have high ionic conductivity (8-12 mS/cm) and acceptable safety properties. Other conductive salts include LiBF₄, LiN(CF₃SO₂)₂ or lithium bis-oxalato borate (LiBOB). The electrolytes currently used are almost exclusively formulated with carbonate solvents. Carbonates are aprotic, polar and have a high dielectric constant and can therefore dissolve lithium salts in high concentrations (≥1 M). They also offer compatibility with cell electrode materials over a wide potential range. Organic solvents such as propylene carbonate (PC), ethylene carbonate (EC), dimethyl carbonate (DMC), ethyl methyl carbonate (EMC) and diethyl carbonate (DEC) are used alone or mostly in mixtures. Organic electrolytes, especially with LiPF₆ as the conductive salt, react with water to form toxic substances such as the fluoric acid HF. Special measures, such as working in dry rooms, are therefore necessary when the organic lithium-ion cells are still open.

The device according to this disclosure is suitable for filling battery cells with electrolytes containing organic solvents, regardless of the type of conductive salt.

In a further advantageous embodiment of the device according to this disclosure, the battery cell is filled with an SO₂-based electrolyte.

As defined above, an SO₂-based electrolyte contains SO₂ not only as an additive at a low concentration, but also at concentrations at which the mobility of the ions of the conductive salt, which is contained in the electrolyte and effects the charge transport, is at least partially, largely, or even fully ensured by the SO₂. The conductive salt is dissolved in the electrolyte and exhibits good solubility therein. It can form a liquid solvate complex with the gaseous SO₂, the SO₂ being bound in said complex. In this case, the vapor pressure of the liquid solvate complex drops significantly compared to pure SO₂ and result in electrolytes with a low vapor pressure. It may also be that, depending on the chemical structure of the conductive salt, the vapor pressure occurring during the production of the electrolyte according to this disclosure is not reduced. The device is suitable for filling battery cells with SO₂-based electrolyte regardless of the type of conductive salt.

In an advantageous embodiment of the SO₂-based electrolyte, the conductive salts are selected from the alkali or alkaline earth halides of group 3A of the periodic table. The 3A elements boron, aluminum, gallium, and indium are preferred. The preferred alkali and alkaline earth metals are lithium, sodium, and calcium. Examples of preferred salts include LiAlCl₄, LiGaCl₄, LiBF₄, LiBCl₄, LiInCl₄, NaAlCl₄, NaGaCl₄, NaBF₄, NaBCl₄, NaInCl₄, Ca(AlCl₄)₂, Ca(GaCl₄)₂, Ca(BF₄)₂, Ca(BCl₄)₂, Ca(InCl₄)₂, Sr(AlCl₄)₂, Sr(GaCl₄)₂, Sr(BF₄)₂, Sr(BCl₄)₂, Sr(InCl₄)₂ and mixtures thereof.

In a further advantageous embodiment of the SO₂-based electrolyte, the conductive salts are selected from the conductive salts according to the following formula (I)

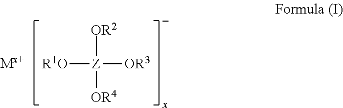

wherein M is a metal selected from the group formed by alkali metals, alkaline earth metals, metals of group 12 of the periodic table of elements, and aluminum; x is an integer from 1 to 3; the substituents R¹, R², R³, and R⁴ are selected independently of one another from the group formed by C₁-C₁₀ alkyl, C₂-C₁₀ alkenyl, C₂-C₁₀ alkynyl, C₃-C₁₀ cycloalkyl, C₆-C₁₄ aryl, and C₅-C₁₄ heteroaryl; and wherein Z is aluminum or boron.

In a further advantageous embodiment of the SO₂-based electrolyte, the conductive salts are selected from the conductive salts according to the following formula (II)

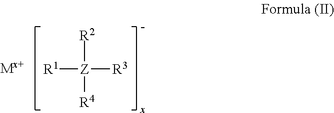

wherein M is a metal selected from the group consisting of alkali metals, alkaline earth metals, Group 12 metals and aluminum; x is an integer from 1 to 3; R¹, R², R³, and R⁴ are independently selected from the group consisting of a halogen atom, a hydroxy group, a chemical group-ORS and a chelate ligand formed jointly by at least two of the substituents R¹, R², R³, and R⁴ and coordinated to Z; wherein R¹, R², R³ and R⁴ are neither four halogen atoms nor four chemical groups-ORS, in particular alkoxy groups wherein the substituent R⁵ is selected from the group consisting of C₁-C₁₀ alkyl, C₂-C₁₀ alkenyl, C₂-C₁₀ alkynyl, C₃-C₁₀ cycloalkyl, C₆-C₁₄ aryl, and C₅-C₁₄ heteroaryl; and wherein Z is aluminum or boron.

A further advantageous embodiment of the SO₂-based electrolyte contains at least two of the above-mentioned conductive salts.

The method according to this disclosure for filling a battery cell with an electrolyte and subsequently sealing the battery cell with the device described above comprises the following steps:
a) Positioning the battery cell in the receiving opening of the process chamber so that the filling opening of the battery cell in the process chamber is arranged in a gas-tight manner,
b) Creating a vacuum in the process chamber and in the battery cell arranged in the receiving opening,
c) Filling the battery cell with the electrolyte by means of the line that is arranged in a gas-tight manner in the opening and reaches the filling opening of the battery cell,
d) Welding the filling opening of the battery cell by means of a laser beam passing through the passage to the filling opening of the battery cell,
e) Removing the sealed battery cell from the receiving opening.

The process according to this disclosure is suitable for all types of battery cells and represents an efficient and cost-effective production method.

In a further advantageous embodiment of the method according to this disclosure, the filling opening of the battery cell arranged in the receiving opening is formed by means of the laser beam passing through the passage.

This measure has the advantage that, according to the method according to this disclosure, the battery cell is positioned in the receiving opening in a single device and that first the filling opening is formed in the form of a hole in the housing base of the battery cell by means of the laser beams which pass through the laser-permeable passage. In the next steps the battery is filled and sealed. This step contributes even more to the efficiency of the process according to this disclosure.

In a further advantageous embodiment of the method according to this disclosure, steps b.1) and b.2) are provided after step b) and before step c):
b.1) Flushing the process chamber and the battery cell arranged in the receiving opening with a gas,
b.2) Generating a vacuum in the process chamber and in the battery cell arranged in the receiving opening.

In a further advantageous embodiment of the method according to this disclosure, an inert gas, preferably nitrogen or argon, or SO₂ is used as the gas in step b.1).

In a further advantageous embodiment of the method according to this disclosure, the filling of the battery cell in step c) takes place several times alternately with the evacuation of the battery cell.

The steps can be repeated several times until all pores of the interior of the battery cell are completely filled with the electrolyte. This measure is particularly suitable for electrolytes with low vapor pressure, e.g., organic electrolytes.

In a further advantageous embodiment of the method according to this disclosure, the line is positioned in step c) in such a way that the filling opening is sealed by means of the line with regard to the interior of the process chamber.

This measure ensures that the filling opening is sealed against the process chamber. An advantage of this design is that the electrolyte does not first enter the process chamber and then the battery cell. Instead, the electrolyte is filled directly into the battery cell through the line. This eliminates the need for an additional step in which the electrolyte solution must be removed from the process chamber.

In a further advantageous embodiment of the method according to this disclosure, the pressure in the process chamber is adjusted during step c) depending on the electrolytes used.

For battery cells with an SO₂-based electrolyte, the pressure in the process chamber is at least 1 bar, preferably 3 bar, more preferably 5 bar and particularly preferably 7 bar.

In a further advantageous embodiment, an ablation welding pulse is carried out by the laser prior to the actual welding process in order to laser off any crystallized electrolyte salt residues that may be present.

### BRIEF DESCRIPTION OF THE DRAWINGS

Further advantageous properties of the device according to this disclosure and the method according to this disclosure will become apparent from the following description of embodiments with reference to the drawing. The figures are not drawn to scale but are schematic representations that only reveal the principle of the device and method according to this disclosure. In the figures, identical reference symbols refer to identical or essentially equivalent elements or groups of elements.

FIG. 1 shows a first embodiment of the device according to this disclosure in a sectional view (schematic view) before the battery cell is placed;

FIG. 2 is an illustration of FIG. 1, with the battery cell having been placed in the receiving opening;

FIG. 3 shows a second embodiment of the device according to this disclosure in a sectional view (schematic view), in which the battery cell is placed in the receiving opening;

FIG. 4 shows the discharge capacity as a function of the number of cycles of four battery cells filled with SO₂-based electrolyte, two of which were filled according to prior art and two according to the method according to this disclosure.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

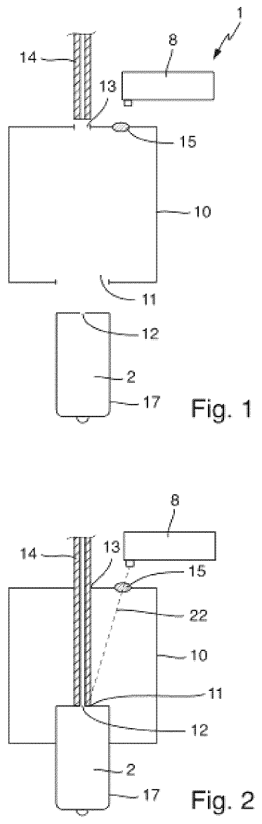

FIG. 1 shows a first embodiment of the device (1) according to this disclosure. In the present embodiment, the device (1) comprises a process chamber (10). There is a receiving opening (11) in the lower part of the process chamber (10) in which a battery cell (2) can be at least partially accommodated. The process chamber (10) can be designed to accommodate battery cells of various designs. The battery cells can be round in the form of so-called wound cells (e.g., designs 14500, 18650, 21700, 26650, 32600, or 46800) or rectangular (e.g., designs PHEV2 and BEV2 hardcase cells) with stacked or flat-wound electrodes inside. The process chamber (10) can be adapted to battery cells of different sizes.

Furthermore, the process chamber (10) has an opening (13) which is suitable for receiving at least one line (14) that transports gases or the electrolyte or the like into the process chamber (10) or directly into the battery cell (2). The gases from the process chamber (10) and/or the battery cell (2) can also be removed through the line (14) by means of a vacuum pump (not shown here). An optional upstream distribution unit, not shown here either, makes it possible to switch to the gases or electrolytes required for the respective process step or to the vacuum pump.

The housing (17) of the battery cell (2) has a filling opening (12) which is advantageously located in the bottom of the battery cell (2). The filling opening (12) has a diameter of 5,000 μm, preferably 2,500 μm, more preferably 1,000 μm, even more preferably 750 μm, still more preferably 500 μm and particularly preferably 250 μm.

The process chamber further comprises a passage (15) through which the laser beams can enter the process chamber (10). The passage (15) is closed with a laser beam permeable material, preferably glass, as described in detail above. Optionally, the passage (15) can be protected from process gases or electrolytes by means of a movable lid, not shown here either, within the process chamber (10). A laser welding device (8) is arranged above the passage (15).

FIG. 2 shows the illustration of FIG. 1, with the battery cell (2) and the line (14) being accommodated in the process chamber. In this illustration, the battery cell (2) is arranged in the receiving opening (11) in such a way that it partially projects into the process chamber (10), so that the filling opening (12), in this embodiment arranged in the bottom of the battery cell (2), is located in the process chamber (10).

The line (14) is movably accommodated in the opening (13) so that it can be lowered into the process chamber (10) if necessary. It can be lowered up to the filling opening (12) of the battery cell (2), as shown in FIG. 2. The line (14) is designed in such a way that the filling opening (12) is sealed by means of the line (14) against the interior of the process chamber (10) when the line (14) meets the filling opening (12).

In this state, shown in FIG. 2, the battery cell (2) can be filled with a desired electrolyte. By means of a suitable seal, e.g., at the tip of the line (14), the battery cell (2) can be filled through the filling opening (12) without large quantities of electrolyte entering the process chamber (10). This prevents, for example, a contamination of the process chamber (10).

After the filling, the filling opening (12) of the battery cell (2) is sealed. In this embodiment, the line (14) is positioned so that it is close to the filling opening (12). In this process step, the welding gas is supplied through the line (14). By lowering the line (14), the welding gas is brought directly to the filling opening (12) to be welded. The filling opening (12) is welded with the laser beam (22) in an electrolyte-tight manner. The laser beam (22) can be aligned vertically or at a suitable angle to the filling opening (12). Preferably, the laser beam (22) is not aligned perpendicular to the filling opening (12), but at a suitable angle, since this prevents possible damage to the components in the battery cell (2), such as electrodes or separators. The laser beam (22) advantageously strikes the filling opening (12) of the battery cell (2) at an angle of preferably 85°, more preferably 80°, more preferably 75°, and even more preferably 70°, and particularly preferably 65°, as shown schematically in FIG. 2.

The welding zone should preferably be twice as large as the filling opening (12). This ensures that there is sufficient material from the housing (17) of the battery cell (2) with which the filling opening (12) can be sealed. This process has the great advantage that no additional material has to be introduced into the process chamber (10) to weld the filling opening (12). The housing (17) is made of a material that can be laser welded. A housing (17) made of steel can be used, for example.

Alternatively, additive welding is also possible by introducing the welding material into the process chamber (10) near the filling opening (12) prior to the welding process.

A second embodiment of the device (1) according to this disclosure can be seen in FIG. 3. The second embodiment has the same design and elements as the first with the difference of additional lines. In detail:

The second embodiment of the device according to this disclosure also has a process chamber (10) in which a receiving opening (11) is provided in the lower part, in which a battery cell (2) can be at least partially accommodated. The process chamber (10) can be designed the same as in the first embodiment.

The process chamber (10) of the second embodiment also has a passage (15) through which the laser beams can pass. The passage (15) is designed the same as in the first embodiment.

Furthermore, the process chamber (10) of the second embodiment also has an opening (13) which is suitable for receiving at least one line (14). The opening (13) and the line (14) are designed the same as in the first embodiment and have the same functions.

In addition to the opening (13) and the line (14), the process chamber (10) of the second embodiment has a further opening (18). A further line (19) can be accommodated in the opening (18) in a gas-tight manner. Furthermore, the line (19) is movably arranged in the opening (18). Likewise, the process chamber (10) of the second embodiment has a further opening (20). A further line (21) can be accommodated in the opening (20) in a gas-tight manner. Furthermore, the line (21) is movably arranged in the opening (20).

In contrast to the first embodiment, in which all gases and liquids can be transported one after the other by means of the single line (14), the supply and/or removal of the gases and/or liquids can take place simultaneously in the second embodiment.

For example, the line (14) can be used to transport the electrolyte and thus the battery cell (2) can be filled through the filling opening (12) through this line (14) after it has been lowered to the filling opening (12) in such a way that a seal against the interior of the process chamber (10) is ensured so that no larger quantities of electrolyte get into the process chamber (10). This prevents, for example, a contamination of the process chamber (1).

Various gases, such as inert gases, SO₂ or welding gas, can be fed into the process chamber (10) through the line (19). An optional upstream distribution unit, not shown here, makes it possible to switch to the gas required for each process step. The line (19) can be lowered into the process chamber (10) if required. It can be lowered up to the filling opening (12) of the battery cell (2). This is advantageous, for example, for laser welding, as it allows the welding gas to be brought directly to the filling opening (12) to be welded.

At the same time, the ambient pressure in the process chamber (10) can be adjusted by means of the further line (21), so that electrolytes can be filled regardless of their respective prevailing vapor pressure and used within the process chamber (10) in such a way that strong gas development is avoided. The line (21) can be connected to an external vacuum pump (23) in order to evacuate the process chamber (10) and the battery cell (2) if necessary.

A further embodiment of the device according to this disclosure, which is not shown in the figures, provides that the process chamber (10) is designed such that it can accommodate two or more battery cells. Two or more battery cells can be filled simultaneously or sequentially. Likewise, two or more battery cells can be sealed simultaneously or one after the other.

The described embodiments are exemplary embodiments of the device according to this disclosure. The positions and the number of the individual openings (13, 18, 20), lines (14, 19, 21), the receiving opening (11), and the passage (15) for the laser beams can vary and be designed in different ways.

The first embodiment according to FIG. 1 and FIG. 2 has one line (14), the second embodiment according to FIG. 3 has three separate lines (14, 19, 21). Two lines or four or more lines can also be used to transport gases and/or liquids into or out of the process chamber (10) and/or battery cell (2).

Upstream valves allow one or more lines to be used simultaneously for different gases and/or liquids. Likewise, two or more passages for laser beams and/or two or more laser welding devices may be present, e.g., if there are two or more battery cells in the device.

Storage tanks, buffer vessels, or backwash tanks can be connected to the line(s) and can be used, for example, to provide electrolytes or to reduce pressure fluctuations. The exact filling quantity of electrolyte can also be determined outside the process chamber. In a preferred embodiment, a tank is always filled and emptied to the same level by means of a fill level control, so that the volume of electrolyte for filling a battery cell is always constant. This method makes it possible to achieve very precise dosing quantities. In a further preferred embodiment, the filling quantity is determined by means of a flow meter. As soon as the flow meter detects the set flow rate of the electrolyte, the electrolyte flow to the cell is interrupted. For example, a Coriolis mass flow meter can be used. This is a flow meter that measures the mass flow of flowing liquids. Its measuring method is based on the Coriolis principle. Very precise dosing quantities can be achieved with this method as well.

The filling time depends, among other things, on the flow velocity. This velocity can be accelerated, for example, by a pressure difference in the region of the storage tanks so that the battery cell is filled more quickly.

The first embodiment of the method according to this disclosure for filling a battery cell with an electrolyte and subsequently sealing the battery cell with the device according to this disclosure described above comprises the following steps:
a) Positioning the battery cell in the receiving opening of the process chamber so that the filling opening of the battery cell in the process chamber is arranged in a gas-tight and liquid-tight manner;
b) Creating a vacuum in the process chamber and in the battery cell arranged in the receiving opening;
c) Filling the battery cell with the electrolyte by means of the line that is arranged in a gas-tight manner in the opening and reaches the filling opening of the battery cell;
d) Welding the filling opening of the battery cell by means of a laser beam passing through the passage to the filling opening of the battery cell;
e) Removing the sealed battery cell from the receiving opening.

The individual steps of the first method are described in more detail below.

Step a) Positioning the battery cell in the receiving opening of the process chamber (10) so that the filling opening (12) of the battery cell (2) in the process chamber (10) is arranged in a gas-tight and liquid-tight manner.

As described in detail above, the device according to this disclosure in all embodiments has a process chamber (10) with a receiving opening (11) into which a battery cell (2) can be introduced in a gas-tight and liquid-tight manner. The battery cell (2) is at least partially introduced into the process chamber (10) in such a way that the filling opening (12) of the battery cell (2) is located within the process chamber (10). A gas and/or liquid exchange along the housing (17) of the battery cell (2) between the process chamber (10) and the environment is prevented by the seal, as can be seen in particular from the illustration in FIG. 2 and FIG. 3. In an alternative, the battery cell (2) is filled with suitable gas before being introduced into the process chamber (10). This can be, for example, an inert gas such as nitrogen or a process gas such as SO₂. In a further alternative of the first embodiment of the method according to this disclosure, before the battery cell (2) is introduced, a battery cell barcode applied to the battery cell is scanned and/or the battery cell (2) is weighed and/or aligned for introduction into the process chamber (10) so that the filling opening (12) of the battery cell (2) is positioned such that the laser beams that pass through the passage (15) into the process chamber (10) hit the filling opening.

Step b) Creating a vacuum in the process chamber (10) and in the battery cell (2) arranged in the receiving opening (11).

In order to remove the gases contained in the process chamber (10) and the battery cell (2) placed in the receiving opening, e.g., air or inert gas such as nitrogen or process gas such as SO₂, a vacuum is applied to the process chamber (10). This can be done via the line (14) in the first embodiment of the device according to this disclosure as shown in FIG. 1 and FIG. 2. In the second embodiment of the device according to this disclosure according to FIG. 3, the vacuum is generated via the line (21). The gases contained are extracted.

Optionally, the following steps can be performed after step b):
b.1) Flushing the process chamber (10) and the battery cell (2) arranged in the receiving opening (11) with a gas,
b.2) Creating a vacuum in the process chamber (10) and in the battery cell (2) arranged in the receiving opening (11).

In step b.1), the process chamber (10) and the battery cell (2) arranged in the receiving opening (11) of the process chamber (10) are flushed with a corresponding gas depending on the electrolyte used. For example, when filling the battery cell (2) with an SO₂-based electrolyte, SO₂ is used as purge gas. When filling with an organic electrolyte, an inert gas, e.g., nitrogen, is used.

Step b.2) serves to remove the purge gas from the process chamber (10) and the battery cell (2) and to promote the filling of the battery cell (2) with the electrolyte.

Step c) Filling the battery cell (2) with the electrolyte by means of the line (14) which is arranged in a gas-tight in the opening (13) and reaches the filling opening (12) of the battery cell (2).

The electrolyte for filling the battery cell (2) is introduced through the line (14). In a first advantageous embodiment of the method according to this disclosure, the line (14) is moved into the process chamber (10) up to the filling opening (12) of the battery cell (2). The line (14) is designed in such a way that the filling opening (12) can be sealed off from the process chamber (10). One advantage of this method is that the electrolyte does not first enter the process chamber (10) and then the battery cell (2), but the electrolyte is filled directly into the battery cell (2) through the line (14). This eliminates the need for additional steps in which the electrolyte solution must be removed from the process chamber (10) and cleaned. In addition, different pressure conditions can be generated by sealing the filling opening (12) through the line in the battery cell (2) and in the process chamber (10). The pressure in the process chamber (10) can be adjusted to the electrolyte used. For example, the vacuum can be maintained in the process chamber (10), or an overpressure can be set. When filling the battery cell with SO₂-based electrolyte, creating an overpressure in the process chamber (10) has proven advantageous. The overpressure can be achieved, for example, by introducing an inert gas such as argon. In this case, the pressure in the process chamber should be at least 1 bar, preferably 3 bar, more preferably 5 bar and particularly preferably 7 bar. After filling the battery cell using the line (14), it is lifted again and removed from the filling opening (12). Furthermore, when filling the battery cell (2) with SO₂-based electrolyte, the remaining overpressure serves to prevent SO₂ from escaping from the battery cell.

Step d) Welding the filling opening (12) of the battery cell (2) by means of a laser beam which passes through the passage (15) to the filling opening (12) of the battery cell (2).

The laser for laser welding is located outside the process chamber (10) and is arranged in such a way that the laser beam (22) can pass through the laser beam-permeable passage (15) into the process chamber (10) and strikes the filling opening (12). Optionally, the filling opening (12) can first be cleaned of any crystallized conductive salt using a laser pulse. The filling opening (12) is then welded tightly using the laser beam (22) so that no electrolyte can escape from the battery (2). In one embodiment of the method according to this disclosure, the process chamber (10) can be filled with the welding gas. In the method according to this disclosure, the welding gas is preferably moved into the process chamber (10) up to the filling opening (12) of the battery cell (2) by means of the line (14), in the first embodiment of the device according to this disclosure as shown in FIG. 1 and FIG. 2, or by means of the line (19), in the second embodiment of the device according to this disclosure as shown in FIG. 3. This means that the welding gas escapes exactly at the point where the laser welding takes place.

Step e) Removing the sealed battery cell from the receiving opening.

The battery cell (2) sealed by laser welding is removed from the device according to this disclosure.

The second embodiment of the method according to this disclosure comprises all steps a) to e) of the method according to this disclosure according to the first embodiment, as described in detail above. In addition, the second embodiment of the method according to this disclosure comprises, after step a), a step a.1), in which the filling opening (12) of the battery cell (2) arranged in the receiving opening (11) is formed by means of the laser beam (22) passing through the passage (15). In detail:

In order for the battery cell (2) to be filled, it must have a filling opening (12). In the second embodiment of the method according to this disclosure, this filling opening (12) is only created when the battery cell (2) is already in the process chamber (2) of the device according to this disclosure. After step a), during which the battery cell (2) is positioned in the receiving opening (11) of the process chamber (10), so that the place where the filling opening (12) of the battery cell (2) is to be produced is arranged in the process chamber (10) in a gas-tight and liquid-tight manner, the laser beam (22), which passes through the passage (15), strikes the filling opening (12) at an angle of preferably 85°, more preferably 80°, more preferably 75°, even more preferably 70°, and particularly preferably 65°. The filling opening (12) is lasered in the desired shape, e.g., as a round hole. In order to protect the elements in the interior of the housing (17) of the battery cell (2), suitable measures can be taken, such as a spacer, preferably in the form of a ring, being attached around the filling opening (12) inside the housing (17) of the battery cell (2). In the event that the lasering releases small parts of the housing (17), these can be extracted by means of a lowered line (14, 19, 21).

In order to describe this disclosure and the method according to this disclosure in more detail, examples of possible steps for filling a battery cell with an SO₂-based electrolyte with an organic electrolyte are described.

Examples of possible steps for filling a battery cell with an SO₂-based electrolyte:
Barcode of the battery cell (2) is scanned,
the battery cell (2) is aligned and weighed,
the battery cell (2) is positioned in the receiving opening (11) of the process chamber (10),
the battery cell (2) and the process chamber (10) are flushed with SO₂ via line (14) or (19),
the line (14) is subsequently sealingly lowered to the filling opening (12) and an overpressure is generated in the process chamber (10),
the battery cell (2) is filled with an SO₂-based electrolyte and the corresponding line (14) is raised again,
the line (14) or (19) is subsequently lowered to the filling opening (12) and the welding gas is allowed to flow out through the lowered line (14) or (19) at the filling opening (12) of the battery cell (2),
the filling opening (12) of the battery cell (2) is closed by laser welding,
the filled battery cell (2) is removed from the process chamber and weighed.

Examples of possible steps for filling a battery cell with an organic electrolyte:
Barcode of the battery cell (2) is scanned,
the battery cell (2) is aligned and weighed,
the battery cell (2) is positioned in the receiving opening (11) of the process chamber (10),
the battery cell (2) and the process chamber (10) are evacuated via line (14) or (21) to remove the gases,
the battery cell (2) and the process chamber (10) are purged with inert gas via line (14) or (19),
the line (14) is then lowered sealingly to the filling opening (12) and the battery cell (2) is filled with the organic electrolyte and the corresponding line (14) is raised again,
the line (14) or (19) is subsequently lowered to the filling opening (12) and the welding gas is allowed to flow out through the lowered line (14) or (19) at the filling opening (12) of the battery cell (2),
the filling opening (12) of the battery cell (2) is closed by laser welding,
the filled battery cell (2) is removed from the process chamber and weighed.
   Experiment 1-Filling with SO₂-Based Electrolyte According to Prior Art and with the Device and Method According to this Disclosure

In this experiment, two identical battery cells were filled with SO₂-based electrolyte. These were battery cells with a positive electrode with lithium nickel manganese cobalt oxide as the active material, a negative electrode made of carbon and an SO₂-based electrolyte with a lithium alkoxy aluminate conductive salt according to formula (I).

Two cells were filled and sealed using the so-called open method that had been common practice until then. According to the prior art, they were filled directly into the opened battery cell. The electrolyte was dripped onto the electrode coil/stack and the experimenter waited until the electrolyte was absorbed into the battery cell. This dripping was carried out until the electrolyte was visible above the electrode coil/stack. Because the open battery cell is filled, this process must be carried out in a dry room or under protective gas. Depending on the size of the battery cell, this process takes 20-60 minutes. The battery cell is then placed in a device for welding the lid to the housing to seal it with the lid component. This transfer must also be carried out in a dry room or under protective gas.

Two further cells were filled and sealed with the device and method according to this disclosure according to the first embodiment.

To determine the discharge capacities, the four battery cells were charged with a current of 50 mA up to an upper potential of 4.3 volts. The corresponding upper potential was maintained until the charging current had dropped to 40 mA. Thereafter, the discharge took place at a current of 50 mA down to a discharge potential of 2.5 volts.

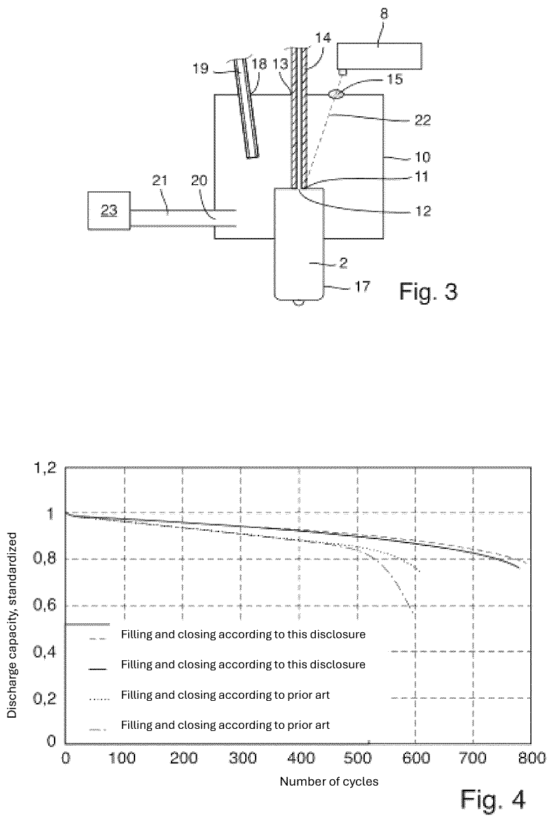

FIG. 4 shows the measurement curves of the four cells. The discharge capacity can be seen over the number of cycles. For better comparison, the discharge capacities were standardized to 1.

The battery cells filled and sealed with the device and the method according to this disclosure show improved behavior compared to the cells filled and sealed according to the prior art. These show a decrease in the standardized discharge capacity after 600 cycles to 0.55 and 0.75 respectively. The cells filled and sealed according to this disclosure still show a discharge capacity of 0.8 at 750 cycles. It can be concluded that the device and the method according to this disclosure distributes the electrolyte homogeneously throughout the battery cell.

Experiment 2-Investigation of the Duration of the Filling According to the Prior Art and with the Device and Method According to this Disclosure

To compare the duration of filling a battery cell, data for filling a conventional lithium-ion cell with an organic electrolyte solution of size 2170 (wound cell with 21 mm diameter and 70 mm length) were compared with the corresponding data of the method according to this disclosure using the device according to this disclosure for filling a battery cell with SO₂-based electrolyte.

TABLE 1
Filling Steps and Duration

| | |
|---|---|
| Conventional Lithium- | Lithium-Ion Battery |
| Ion Battery | SO₂ Electrolyte |
| Organic Electrolyte | High Electrode Density |

Filling Steps

| | | |
|---|---|---|
| Evacuate cell | | Evacuate cell |
| Cell is filled with the lid | | Cell is filled through the filling |
| open | | hole (0.2 mm) |
| Cell remains under vacuum; | | Cell is sealed with the laser in |
| pressure cycled | | the same device |
| Optional for high electrode | | |
| density: | | |
| Second filling | | |
| Cell remains under vacuum; | | |
| pressure cycled | | |
| Complete filling of the cell | | Complete filling and sealing of |
| | | the cell |
| Approx. 20 min | Length of | <1 min |
| | Time | |

Filling the battery cells with SO₂-based electrolyte is about 20 times faster than filling a conventional lithium-ion battery with organic electrolyte solution.

Experiment 3-Investigation of the Duration of the Filling According to the Prior Art and with the Device and Method According to this Disclosure

To compare the duration of filling a battery cell, data for filling a lithium-ion cell with an SO₂-based electrolyte according to the prior art were compared with the corresponding data of the method according to this disclosure using the device according to this disclosure for filling a battery cell also with an SO₂-based electrolyte.

TABLE 2
Filling Steps and Duration

| | | Lithium-Ion Battery |
|---|---|---|
| Lithium-Ion Battery | | SO₂ Electrolyte |
| SO₂ Electrolyte | | High Electrode Density |
| High Electrode Density | | Method According to this |
| Prior Art | | Disclosure Using the Device |
| Filling Steps | | According to this Disclosure |
| Cell under protective gas or in | | Evacuate cell |
| a dry room | | |
| Cell is filled with the lid open | | Cell is filled through the |
| | | filling hole |
| Filled by dripping in the | | Cell is sealed with the laser |
| electrolyte | | in the same device |
| Waiting time until the | | |
| electrolyte has penetrated the | | |
| cell | | |
| Further filling by dripping in | | |
| the electrolyte | | |
| Waiting time until the | | |
| electrolyte has penetrated the | | |
| cell | | |
| Complete filling of the cell | | Complete filling and sealing |
| | | of the cell |
| Approx. 20 min | Length of | <1 min |
| | Time | |

Filling the battery cells with SO₂-based electrolyte using the method and device according to this disclosure is about 20 times faster than filling using the prior art method.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

What is claimed is:

1. A device for filling a battery cell with an electrolyte and for subsequently sealing said battery cell, said device comprising:
a process chamber which further comprises:
a receiving opening in which the battery cell is at least partially accommodated such that a filling opening of the battery cell is arranged in the process chamber, and
an opening suitable for receiving a line for filling the battery cell,
wherein the process chamber is gas-tight and liquid-tight with the battery cell and line,
further wherein the process chamber has a passage through which laser beams can pass to close the filling opening of the battery cell so that the battery cell at least partially accommodated in the process chamber can be filled with the electrolyte and then sealed.

2. The device according to claim 1, wherein the passage comprises a laser beam-permeable material.

3. The device according to claim 2, wherein the laser beam-permeable material is selected from the group consisting of glass, diamond, sapphire, polymers and thin/thick film coatings and glass fiber reinforced plastics.

4. The device according to claim 1, wherein the laser beam strikes the filling opening of the battery cell at an angle selected from the group consisting of 90°, 80°, 75°, 70° and 65°.

5. The device according to claim 1, wherein the filling opening is formed in a housing of the battery cell.

6. The device according to claim 1, wherein the filling opening is arranged in the bottom region of the housing of the battery cell.

7. The device according to claim 1, wherein the filling opening has a diameter selected from the group consisting of: 5,000 μm, 2,500 μm, 1,000 μm, 750 μm, 500 μm and 250 μm.

8. The device according to claim 1, wherein the line is configured to be movable such that the filling opening is sealed by the line with regard to the interior of the process chamber.

9. The device according to claim 1, wherein the process chamber has further openings in which further lines can be accommodated in a gas-tight manner, wherein the line and the further lines are movable within the opening and further openings.

10. The device according to claim 1, wherein the electrolyte is an SO₂-based electrolyte.

11. A method for filling a battery cell with an electrolyte and subsequently sealing the battery cell using the device according to claim 1, the method comprising:
a) positioning the battery cell in the receiving opening of the process chamber so that the filling opening of the battery cell in the process chamber is arranged in a gas-tight and liquid-tight manner;
b) creating a vacuum in the process chamber and in the battery cell arranged in the receiving opening;
c) filling the battery cell with the electrolyte using the line arranged in the opening in a gas-tight manner and reaching the filling opening of the battery cell;
d) welding the filling opening of the battery cell using a laser beam that passes through the passage to the filling opening of the battery cell; and
e) removing the sealed battery cell from the receiving opening.

12. The method according to claim 11, wherein the filling opening of the battery cell arranged in the receiving opening is formed by the laser beam passing through the passage.

13. The method according to claim 11, further comprising, after step b) and before step c):
b.1) flushing the process chamber and the battery cell arranged in the receiving opening with a gas, and
b.2) creating a vacuum in the process chamber and in the battery cell arranged in the receiving opening.

14. The method according to claim 13, wherein in step b.1) an inert gas is used as the gas, the inert gas selected from the group consisting of nitrogen, argon and SO₂.

15. The method according to claim 11, wherein the filling of the battery cell in step c) takes place several times alternately with the vacuuming of the battery cell.

16. The method according to claim 11, wherein in step c) the line is positioned such that the filling opening is sealed by means of the line with regard to the interior of the process chamber.

17. The method according to claim 11, wherein during step c) the pressure in the process chamber is adjusted depending on the electrolytes used.

18. The method according to claim 17, wherein for an SO₂-based electrolyte the pressure in the process chamber is selected from the group consisting of: at least 1 bar, at least 3 bars, at least 5 bars and at least 7 bars.
